(19) United States
(12) Patent Application Publication
(10) Pub. No.: US 2013/0092695 A1
(43) Pub. Date: Apr. 18, 2013

(54) COOKWARE

(71) Applicant: KUO-WEI YEH, TAINAN CITY (TW)

(72) Inventor: KUO-WEI YEH, TAINAN CITY (TW)

(21) Appl. No.: 13/273,287

(22) Filed: Oct. 14, 2011

(51) Int. Cl. A47J 36/00

(52) U.S. Cl. 220/573.1

(57) ABSTRACT

A cookware is revealed. The cookware includes a pot having a receiving space with an opening facing upward. An upper edge of the pot extends outward and downward to form a pendent edge. Thus a heat storage space is formed between the pendent edge and a pot wall. While heating the pot, heat is accumulated and stored in the heat storage space so that cooking temperature is increased and cooking time is reduced. Therefore energy-saving is achieved.

### BACKGROUND OF THE INVENTION

1. Field of the Invention

The present invention relates to a cookware, especially to a cookware that stores heat energy for rising cooking temperature, and reducing heating time so as to save energy.

2. Description of Related Art

Refer to FIG. 9, a cookware 2 available on the market is revealed. The cookware 2 mainly includes a pot 21 which is a container having a receiving space 22 and an opening facing upward, a pot bottom 211 and a pot wall 212. The pot wall 212 is connected to the pot bottom 211. Food is put into the receiving space 22 for being cooked.

After the gas stove being turned on, the burning gas flame heats the cookware 2 continuously and the temperature of the cookware 2 rises to cook food.

There are three zones of flame, an inner zone (inner flame), a middle zone and an outer zone (outer flame). The inner zone contains unburned gas because the supply of the oxygen is deficient. The outer zone is where the chemical reaction is taking place. The supply of the oxygen is sufficient so that the complete combustion rises the temperature and makes the outer flame the hottest. However, the heat from the hottest outer flame is dissipated along the outer surface of the pot into the air and the pot wall is cooled by air. Thus the pot is unable to reach high temperature for cooking. Moreover, the loss of heat makes it take longer time to cook the food and more energy is consumed.

Thus there is room for improvement and a need to provide a novel cookware that overcomes shortcomings of cookware available now.

### SUMMARY OF THE INVENTION

Therefore it is a primary object of the present invention to provide a cookware that stores heat energy, rises heating temperature, and reduces heating time so as to save energy.

In order to achieve the above object, a cookware of the present invention includes a pot and a receiving space having an opening facing upward. An upper edge of the pot extends outward and downward to form a pendent edge. Thus a heat storage space is formed between the pendent edge and the pot wall.

Thereby once the pot is heated by flames, heat from the hottest outer flame is moved along the outer surface of the pot and is accumulated in the heat storage space. Thus energy is not dissipated, high temperature is attained around the pot wall and cooking temperature is increased. Therefore cooking time is reduced and energy saving target is achieved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing a front view of an embodiment of a cookware according to the present invention;

FIG. 2 is a schematic drawing showing the embodiment in FIG. 1 being heated for cooking;

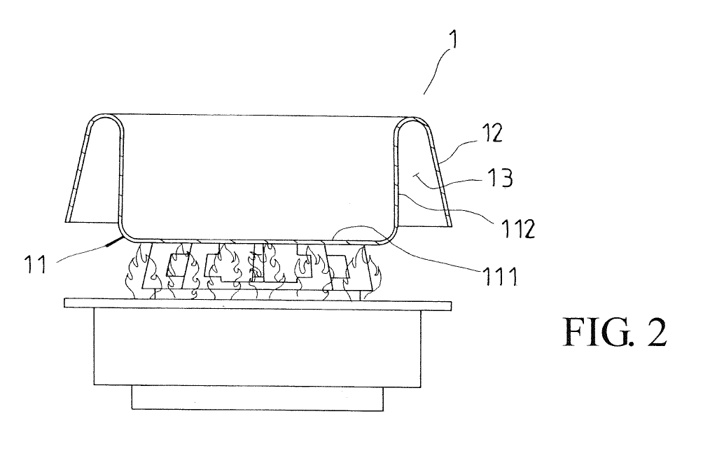

FIG. 3 is a schematic drawing showing a work of another embodiment according to the present invention;

FIG. 4 is a schematic drawing showing a pan of a further embodiment according to the present invention;

FIG. 5 is a schematic drawing showing another pan of a further embodiment according to the present invention;

FIG. 6 is a schematic drawing showing a normal pot of a further embodiment according to the present invention;

FIG. 7 is a schematic drawing showing a kettle of a further embodiment of according to the present invention;

FIG. 8 is a schematic drawing showing another normal pot of a further embodiment according to the present invention;

FIG. 9 is a schematic drawing showing a cookware available now.

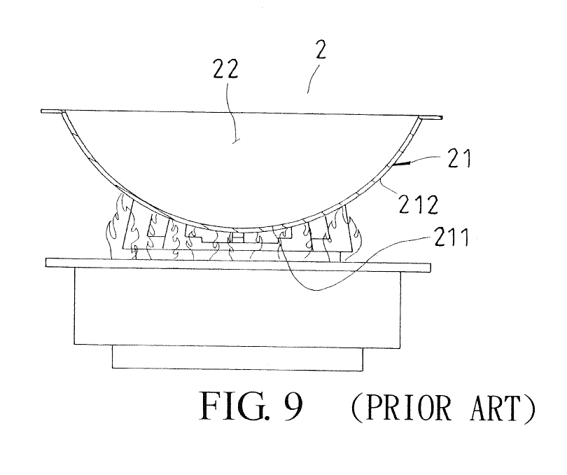

### DETAILED DESCRIPTION OF THE PREFERRED EMBODIMENT

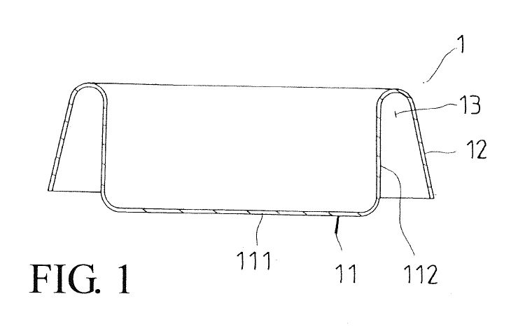

Refer to FIG. 1, a cookware 1 of the present invention mainly includes a pot 11 that is a container with a receiving space and an opening facing upward. The pot 11 consists of a pot bottom 111 and a pot wall 112. The pot wall 112 is connected to the pot bottom 111. Moreover, an upper edge of the pot wall 112 extends outward and downward to form a pendent edge 12. There is a gap between the pendent edge 12 and the pot wall 112 of the pot 11 so as to form a heat storage space 13.

Thereby when the pot 11 is heat by flames, the hottest outer flame runs along the outer surface of the cookware 1. Due to the pendent edge 12, the heat dissipation of the outer fame is delayed and reduced. The high temperature outer flame comes in contact with the pot wall for a longer time, allowing more time for heat absorption. Moreover, heat from the outer zone of the flame is accumulated in the heat storage space 13 and then is transferred to the pot 11. These all get more heat to the pot 11 and cooking temperature of the cookware 1 is increased. Thus food is ready in a shorter time and energy is saved.

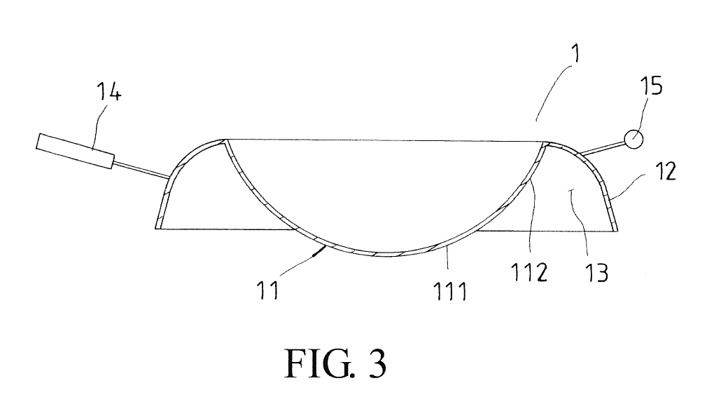

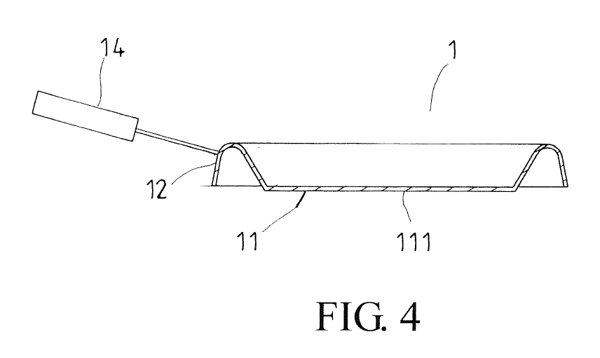

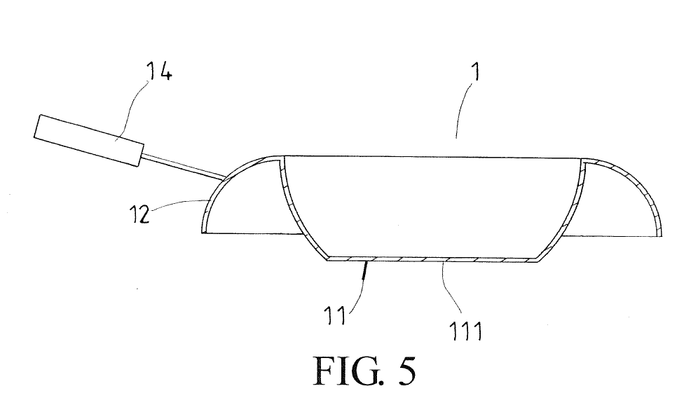

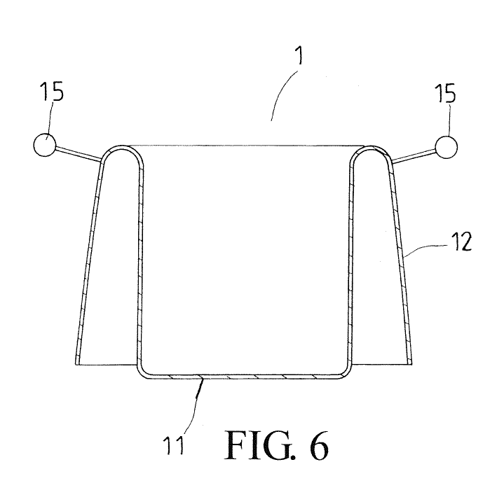

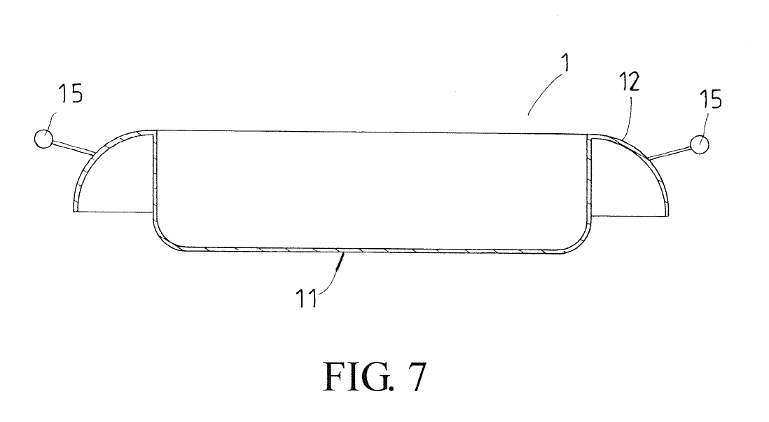

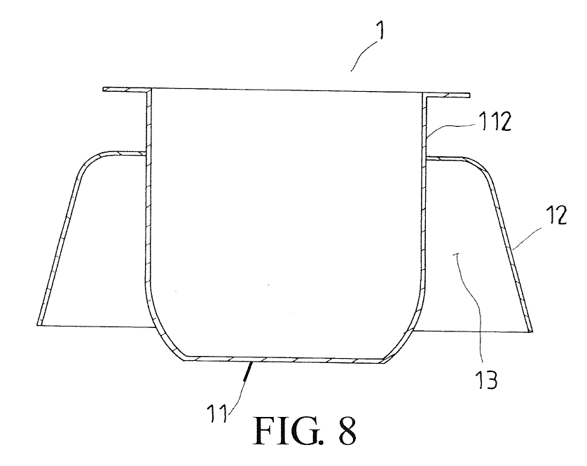

Refer to FIG. 3, in another embodiment, a pot bottom 111 of a pot 11 of a cookware 1 is a curved surface and a pot wall 112 is connected to and extending from the pot bottom 111 so as to form a work. A handle 14 and an ear 15 are disposed on a pendent edge 12 of the cookware 1. Refer to FIG. 4, a further embodiment is revealed. This embodiment is a pan in which a pot bottom 111 of a pot 11 of a cookware 1 is a flat surface and a handle is arranged at a pendent edge 12. Refer to FIG. 5, another type of pan is disclosed. A further embodiment of the cookware 1 shown in FIG. 6 is a normal pot having a certain depth and two corresponding ears 15 are set on a pendent edge 12 of the pot 1. Refer to FIG. 7, this embodiment is a kettle with a shallow depth and also having two corresponding ears 15 arranged at a pendent edge 12 of the pot 1. Refer to FIG. 8, a normal pot also includes a pendent edge 12 set under the upper edge of a pot wall 112 of a pot 11 of a cookware 1 so as to produce a heat storage space 13 between the pendent edge 12 and the pot wall 112.

Furthermore, the pot 11 of the cookware 1 is made from metal, ceramic or glass.

In summary, the cookware of the present invention includes a heat storage space around a pot wall of a pot thereof so that heat from the outer flame is accumulated and saved in the heat storage space. Then the heat accumulated and stored in the heat storage space is transferred to the pot so that more heat is used to cook food without being dissipated to the air. The cooking time is reduced up to 30˜40% and energy is saved effectively.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A cookware comprising: a pot having a receiving space with an opening facing upward; wherein the pot includes a pot bottom, and a pot wall connected to the pot bottom; the pot wall extends outward and downward to form a pendent edge; there is a gap between the pendent edge and the pot wall so as to form a heat storage space.

2. The device as claimed in claim 1, wherein the pot bottom of the pot of the cookware is curved and the pot wall is connected to and extending from the curved pot bottom so as to form a work.

3. The device as claimed in claim 2, wherein the pendent edge of the cookware is disposed with at least one handle and at least one ear.

4. The device as claimed in claim 1, wherein the pot bottom of the pot of the cookware is flat so as to form a pan.

5. The device as claimed in claim 4, wherein the pendent edge of the cookware is disposed with at least one handle.

6. The device as claimed in claim 1, wherein the cookware is a normal pot having a certain depth.

7. The device as claimed in claim 6, wherein the pendent edge of the cookware is disposed with at least one ear.

8. The device as claimed in claim 1, wherein the cookware is a kettle with a shallow depth.

9. The device as claimed in claim 8, wherein the pendent edge of the cookware is disposed with at least one ear.

10. The device as claimed in claim 1, wherein the pendent edge of the cookware is connected to an upper edge of the pot wall.

11. The device as claimed in claim 1, wherein the pendent edge of the cookware is connected under an upper edge of the pot wall.

12. The device as claimed in claim 1, wherein the pot is made from metal, ceramic or glass.
